(19) United States
(12) Patent Application Publication
(10) Pub. No.: US 2012/0096693 A1
(43) Pub. Date: Apr. 26, 2012

(54) VAULT AND VAULT/CASKET DISPLAY

(75) Inventors: Paul Eric Herridge, Auburn, NY (US); Dan Meiser, Wilder, KY (US); Ilija Rojdev, Cincinnati, OH (US); Edward Charles Wolff, Rochester, NY (US)

(73) Assignee: BATESVILLE SERVICES, INC., Batesville, IN (US)

(21) Appl. No.: 13/276,701

(22) Filed: Oct. 19, 2011

Related U.S. Application Data
(60) Provisional application No. 61/394,932, filed on Oct. 20, 2010.

(51) Int. Cl. A61G 17/00

(52) U.S. Cl. 27/35

(57) ABSTRACT

In one aspect, a vault comprises a vault base, a vault lid on the base, the lid including structure on an upper surface thereof for receiving memorialization panels, and at least one memorialization panel received by the receiving structure on the lid. In another aspect, a vault and casket display comprises a vault base, a pair of supports spanning the vault base, and a casket supported on the pair of supports.

### RELATED APPLICATIONS

This application claims priority to U.S. Provisional Patent Application Ser. No. 61/394,932 filed Oct. 20, 2010, which is hereby incorporated by reference herein as if fully set forth in its entirety.

### FIELD

The subject matter herein relates generally to caskets and vaults, and more particularly to improvements in vaults and to displays for caskets and vaults.

### BACKGROUND

For above-ground or below-ground interment of the body of a deceased, the body is typically placed in a casket. The casket may be placed in a vault if greater protection for the casket and body is desired.

Casket vaults may be fabricated from concrete or synthetic resinous material. Examples of casket vaults fabricated from synthetic resinous material are shown in U.S. Pat. No. 5,245,733 issued Sep. 21, 1993 for Combination Burial Vault/Casket, U.S. Pat. No. 5,321,873 issued Jun. 21, 1994 for Burial Container, and U.S. Pat. No. 6,282,763 issued Sep. 4, 2001 for Burial Container And Methods Of Making, all of which are hereby incorporated by reference herein as if fully set forth in their entirety. Another example of a synthetic resinous material vault is disclosed in the assignee's US Patent Application Publication No. 2011/0107568 published May 12, 2011 for Casket Vault, which is hereby incorporated by reference herein as if fully set forth in its entirety.

It is desirable to improve upon the vault of the '768 publication and to provide novel techniques for displaying and merchandising vaults and caskets.

### SUMMARY

In one aspect, a vault comprises a vault base, a vault lid on the base, the lid including structure on an upper surface thereof for receiving memorialization panels, and at least one memorialization panel received by the receiving structure on the lid.

The memorialization panel receiving structure can comprise a pair of generally rectangular frames separated by a generally oval frame, and the at least one memorialization panel can comprise a pair of generally rectangular memorialization panels, one of which is received in each generally rectangular frame, and a generally oval memorialization panel received in the generally oval frame. The vault lid can include a generally horizontally oriented threaded hole for threadably receiving a memorial record tube assembly therein. The vault lid can further include a rectangular plaque which covers an end of the memorial record tube assembly installed in the hole. The vault can further include a pair of transverse slots in an outer surface of a bottom of the vault base, a pair of longitudinal slots in the outer surface of the bottom of the vault base, or both. The vault can further include a generally planar gasket between the vault lid and the vault base that is compressed between confronting lid and base generally horizontal surfaces and between confronting lid and base generally vertical surfaces during securement of the lid on the base. The vault base can include threaded inserts, for example stainless steel threaded inserts, molded therein and the lid can be secured to the base by bolts, for example stainless steel bolts, that pass through holes in the vault lid and are threaded into the inserts in the base. There can be three inserts and bolts per side of the vault and one insert and bolt per end of the vault. The vault base and lid can each have inner and outer walls and a structural filler material can be disposed between the inner and outer walls. The inner and outer walls of the base and lid can be fabricated of a synthetic resinous material. The structural filler material can be structural foam. The vault base can include a pair of end walls and can further include a cable ledge extending across each end wall and adapted to receive a length of cable positioned thereunder such that the cable can be used to raise or lower the vault. The vault can further include an axle removably mounted to the vault base and a wheel removably mounted to each end of the axle, and a handle removably mounted to the vault, the handle including a first pair of ends received underneath the vault base, a second pair of ends adapted to be grasped by a user, and structure between the first and second pair of ends that engages an end wall of the vault, whereby lifting the second pair of ends creates a couple applied to the vault thereby permitting an end of the vault to which the handle is mounted to be lifted by the user.

The vault can include an alternative embodiment of a wheel and axle assembly removably mounted to the vault, the wheel and axle assembly including an axle removably mounted to the vault base and a wheel removably mounted to each end of the axle, the axle including a stationary pin attached near one end thereof and a spring loaded pin attached near an opposite end thereof, the pins removably received in respective holes in a bottom of the vault base. Each hole can be a blind hole in a longitudinal extending rib of the bottom of the vault base. The axle can be a rectangular tube and each wheel can be adapted to removably mate with the rectangular tube.

The vault can include an alternative embodiment of a handle assembly removably mounted to the vault, the handle assembly including a pair of rearwardly extending handles adapted to be grasped by a user, a forwardly extending foot adapted to engage a bottom of the vault, and structure between the handles and the foot adapted to engage an end wall of the vault, whereby lifting the pair of handles creates a couple applied to the vault thereby permitting an end of the vault to which the handle assembly is mounted to be lifted by the user. The handle assembly can further comprise an upper horizontal member, each of the pair of handles connected to a respective end of the horizontal member, a lower horizontal member, and a vertical member connected to the upper horizontal member and the lower horizontal member at respective ends of the vertical member. The handle assembly can further comprise a forwardly extending member connected to a lower end of the vertical member, the foot being connected to a forward end of the forwardly extending member. The foot can be a horizontal member connected to an upper surface of the forward end of the forwardly extending member. Each of the pair of handles can be a round tube, and the upper and lower horizontal members, vertical member, forwardly extending member, and foot horizontal member can be rectangular tubes. The vault can further include a pocket formed in a bottom of the vault base which receives the foot.

In another aspect, a vault and casket display comprises a vault base, a pair of supports spanning the vault base, and a casket supported on the pair of supports.

The vault base has upper side edges and each of the supports can have a downturned end portion that fits over a respective upper side edge of the vault base. The display can further comprise a pair of posts that engage an upper side edge of the vault base and that also engage a side edge of the vault lid and position the lid at an angle of between about 0 degrees and about 90 degrees relative to a generally horizontal support surface atop which the vault base and vault lid are supported, for example at an angle of about 60 degrees or about 45 degrees. The vault base can include a plurality of threaded inserts in the upper side edge and the vault lid can include a plurality of through holes in the side edge, and each of the posts can include a generally vertical portion and an upwardly and forwardly extending portion at an upper end of the generally vertical portion, the generally vertical portion including a threaded lower end which is threaded into one of the threaded inserts in the vault upper side edge, an end of the upwardly and forwardly extending portion including a tapped hole therein, and a threaded fastener inserted through one of the through holes in the vault lid side edge and threaded into the tapped hole. Alternatively, each of the posts includes a generally vertical portion, a generally horizontal portion extending in a rearward direction from an upper end of the generally vertical portion, and an upwardly and forwardly extending portion extending from the upper end of the generally vertical portion, the generally vertical portion resting atop a ledge of the vault base, the generally horizontal portion including a through hole, a first threaded fastener inserted through the through hole and threaded into one of the threaded inserts in the upper edge of the vault base, an end of the upwardly and forwardly extending portion having a tapped hole therein, and a second threaded fastener inserted through one of the through holes in the vault lid edge and threaded into the tapped hole.

In another aspect, a casket vault comprises a vault base adapted to receive therein a casket, a vault lid closable on the vault base, a wheel and axle assembly removably mounted to the vault base, the wheel and axle assembly including an axle removably mounted to the vault base and a wheel removably mounted to each end of the axle, and a handle assembly removably mounted to the vault base, the handle assembly including a pair of rearwardly extending handles adapted to be grasped by a user, a forwardly extending foot adapted to engage a bottom of the vault base, and structure between the handles and the foot adapted to engage an end wall of the vault base, whereby lifting the pair of handles creates a couple applied to the vault thereby permitting an end of the vault to which the handle assembly is mounted to be lifted by the user and rolled on the wheels.

The axle can include a stationary pin attached near one end thereof and a spring loaded pin attached near an opposite end thereof, the pins removably received in respective holes in the bottom of the vault base. Each hole can be a blind hole in a longitudinal extending rib of the bottom of the vault base. The axle can be a rectangular tube and with each wheel adapted to removably mate with the rectangular tube. The handle assembly can further comprise an upper horizontal member, each of the pair of handles connected to a respective end of the horizontal member, a lower horizontal member, and a vertical member connected to the upper horizontal member and the lower horizontal member at respective ends of the vertical member. The handle assembly can further comprise a forwardly extending member connected to a lower end of the vertical member, the foot being connected to a forward end of the forwardly extending member. The foot can be a horizontal member connected to an upper surface of the forward end of the forwardly extending member. Each of the pair of handles can be a round tube, and the upper and lower horizontal members, vertical member, forwardly extending member, and foot horizontal member can be rectangular tubes. The vault can further include a pocket formed in the bottom of the vault base which receives the foot. The vault base and lid can each have inner and outer walls and a structural filler material disposed between the inner and outer walls. The inner and outer walls of the base and lid can be fabricated of a synthetic resinous material, and the structural filler material can be structural foam.

### DRAWINGS

FIG. 1 is a perspective view of the vault.

FIG. 2 is an exploded perspective view of the vault.

FIG. 2A is a perspective view of the vault with detachable wheels and detachable handle.

FIGS. 3A and 3B are partial perspective views of the MEMORIAL RECORD TUBE™ assembly and cover plate for the vault.

FIG. 4 is a perspective view of the vault body used as a display for displaying a casket.

FIGS. 5A-5D are various views of a technique for displaying the vault lid with the vault base.

FIGS. 6A-6D are various views of an alternative technique for displaying the vault lid with the vault base.

FIG. 7 is an end view of FIG. 4.

FIGS. 8A-8C are cross-sections of various portions of the vault.

FIGS. 9A-9C are various views of the vault being lifted by cables.

FIG. 10 is a cross-sectional view of the vault taken along its longitudinal center line.

FIGS. 11A-11G are various views of alternative embodiments of the handle assembly and wheel and axle assembly.

### DESCRIPTION

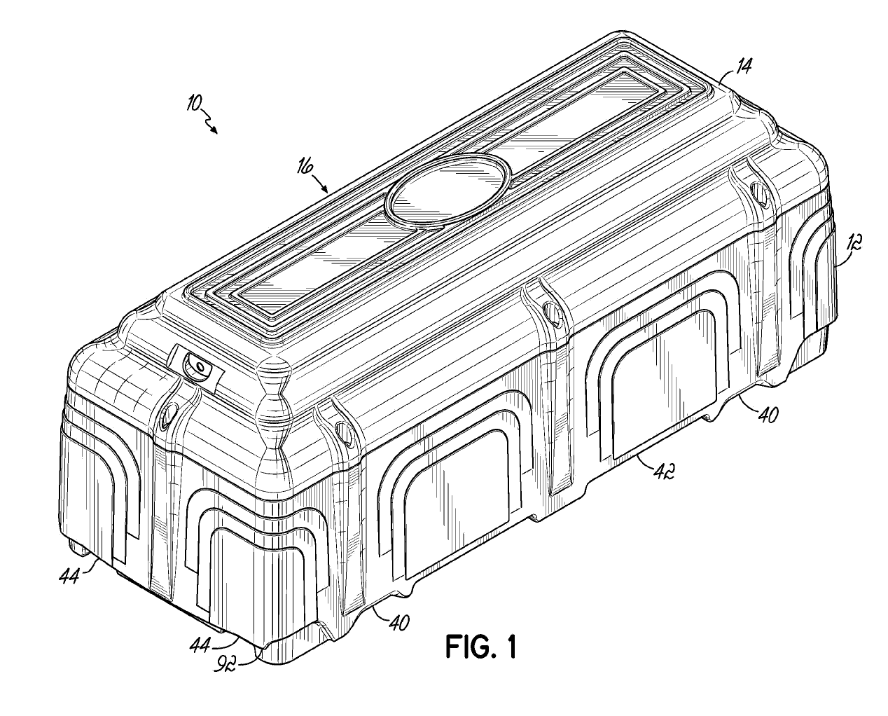

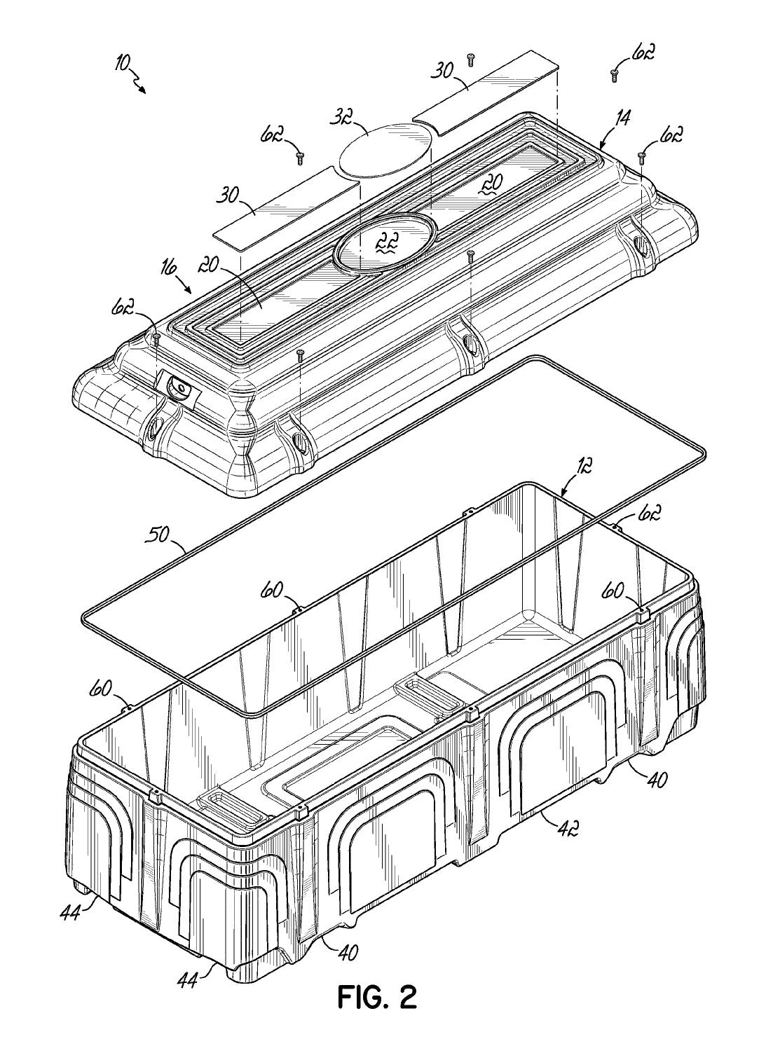

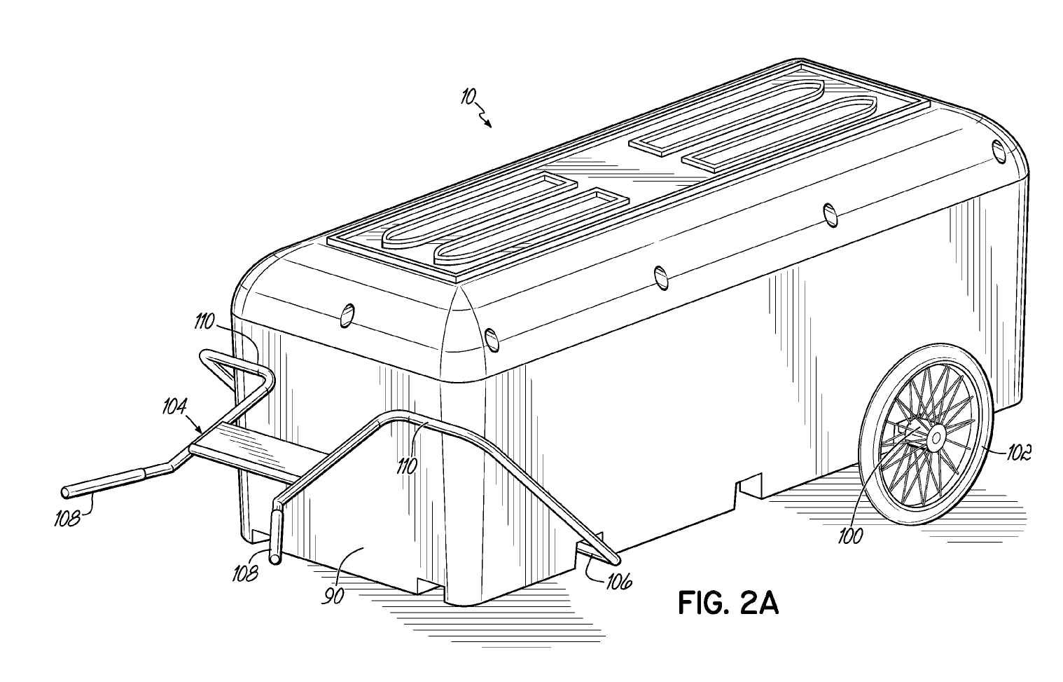

In one aspect, and referring first to FIG. 1, a vault 10 according to the principles of the invention comprises a vault base 12 and a vault lid 14 securable on the base 12. Referring to FIGS. 1 and 2, the lid 14 includes structure 16 on an upper surface thereof for receiving memorialization panels. The memorialization panel receiving structure 16 can comprise a pair of generally rectangular frames 20, 20 separated by a generally oval frame 22. A pair of generally rectangular memorialization panels 30, 30, are received in each generally rectangular frame 20, 20, and a generally oval memorialization panel 32 is received in the generally oval frame 22. The memorialization panels 30 and 32 can be 0.032 inch thick aluminum attached with VHB double sided tape, for example. Alternatively, areas 20, 22 could include permanent ornamentation molded in during the molding process.

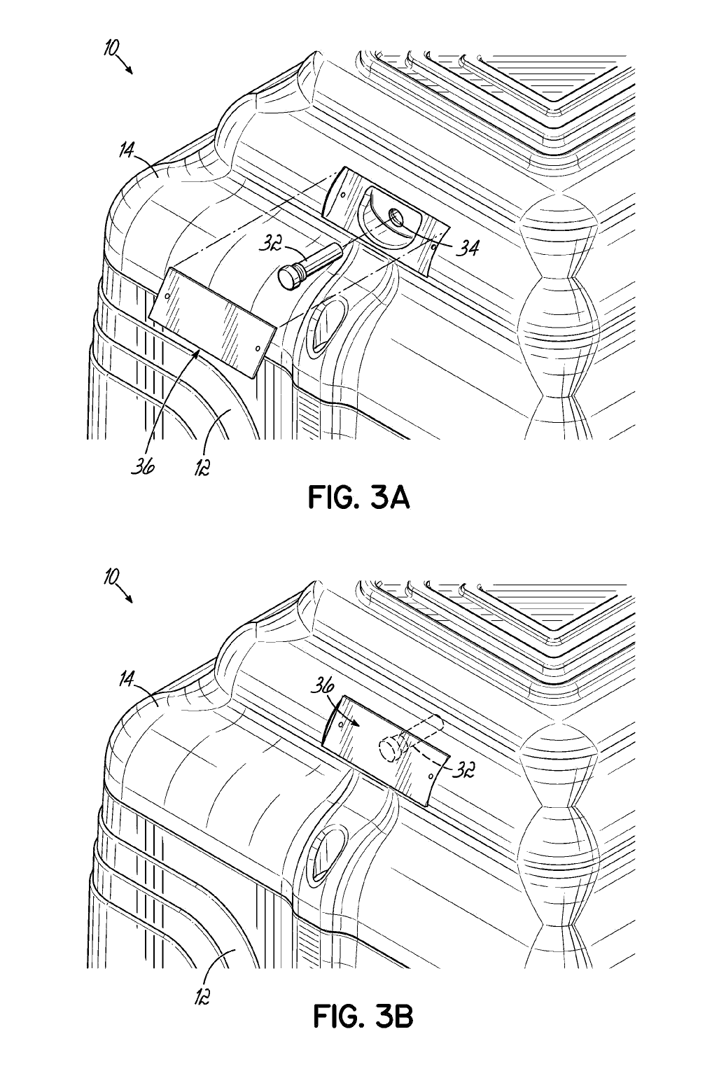

Referring to FIGS. 3A and 3B, the vault lid 14 can include a generally horizontally oriented threaded hole 34 for threadably receiving a memorial record tube assembly 36 therein. The vault lid 14 can further include a rectangular plaque 16 which covers an end of the memorial record tube assembly 36 installed in the hole 34.

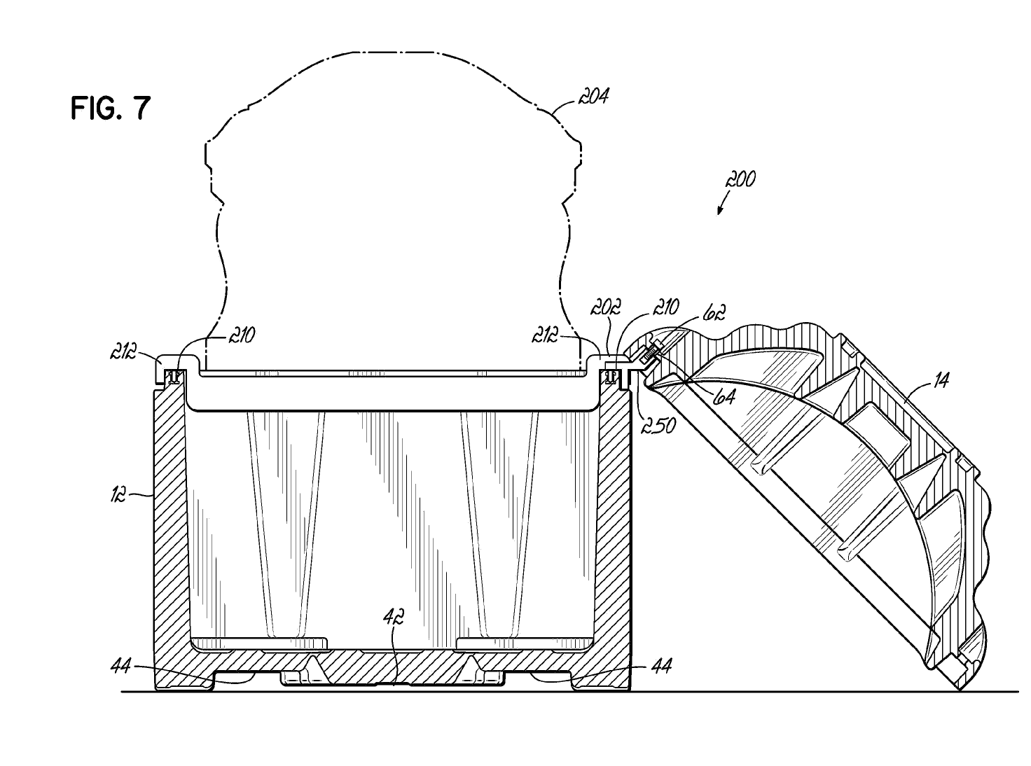

Referring to FIGS. 1, 2, and 7, for example, the vault 10 can further include a pair of transverse slots 40, 40 in an outer surface of a bottom 42 of the vault base 12, a pair of longitudinal slots 44, 44 in the outer surface of the bottom 42 of the vault base 12, or both. Transverse slots 40, 40 facilitate lowering the vault with a casket/vault lowering device, and longitudinal slots 44, 44 facilitate handling the vault with a fork lift.

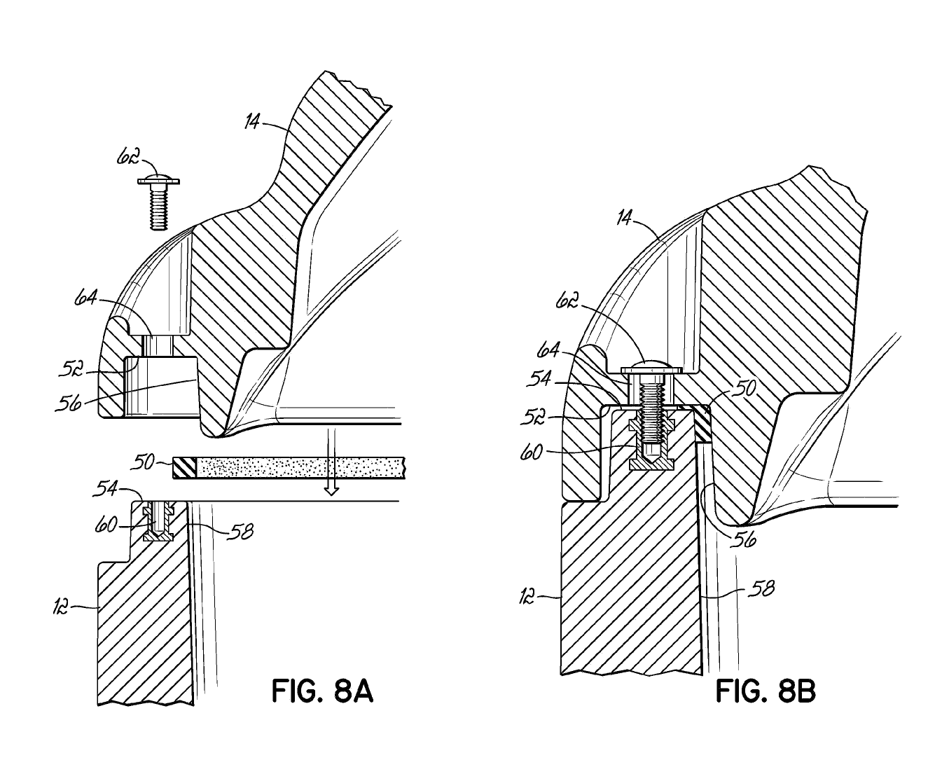

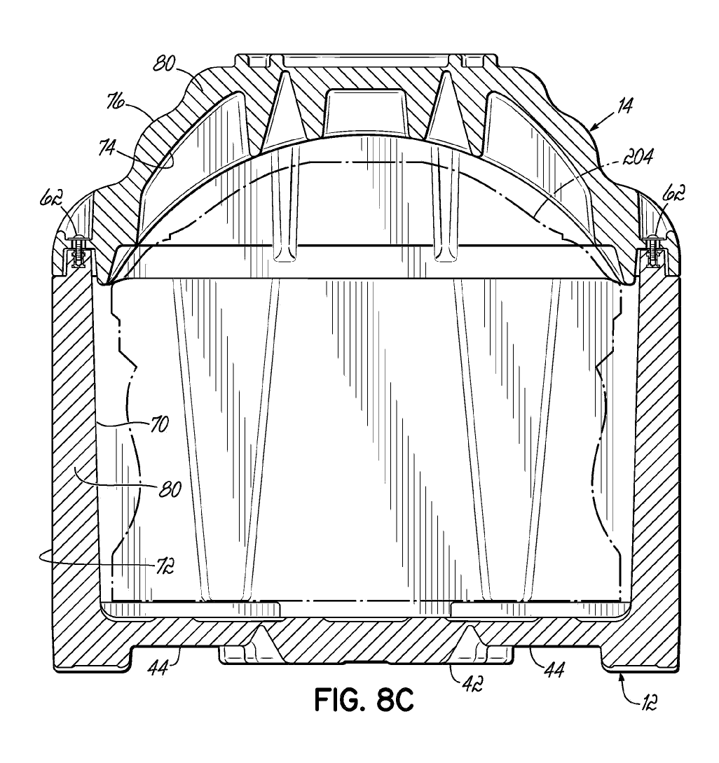

Referring to FIGS. 8A, 8B, and 8C, the vault 10 can further include a gasket, for example a generally planar gasket 50 fabricated of rubber for example, between the vault lid 14 and the vault base 12 that is compressed between confronting lid and base generally horizontal surfaces 52, 54, respectively, and between confronting lid and base generally vertical surfaces 56, 58, respectively, during securement of the lid 14 on the base 12. Alternatively the gasket material could be butyl. The vault base 12 can include threaded inserts 60, for example stainless steel threaded inserts, molded therein and the lid 14 can be secured to the base 12 by bolts 62, for example stainless steel bolts, that pass through holes 64 in the vault lid 14 and are threaded into the inserts 60 in the base 12. There can be three inserts 60 and bolts 62 per side of the vault 10 and one insert 60 and bolt 62 per end of the vault 10.

Referring to FIG. 8C, the vault base 12 and lid 14 can each have inner and outer walls 70, 72, and 74, 76, respectively, and a structural filler material 80 can be disposed between the inner and outer walls. The inner and outer walls 70, 72 and 74, 76 of the base 12 and lid 14 can be fabricated of a synthetic resinous material. The structural filler material can be structural foam 80. For example, the walls can be fabricated of linear low density polyethylene or polypropylene, and the structural foam can be urethane foam or polyethylene foam. Other suitable materials can be used. Such a construction produces a vault that weighs on the order of about 225 lbs, as opposed to conventional concrete vaults weighing as much as 3,000 to 3,500 lbs.

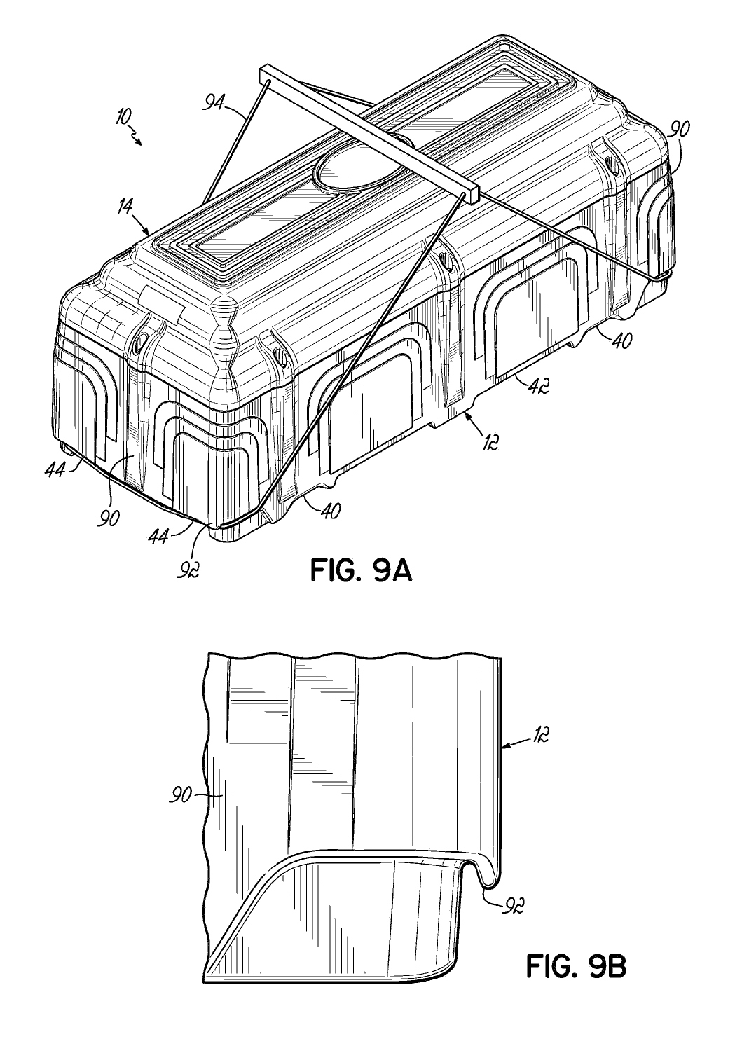

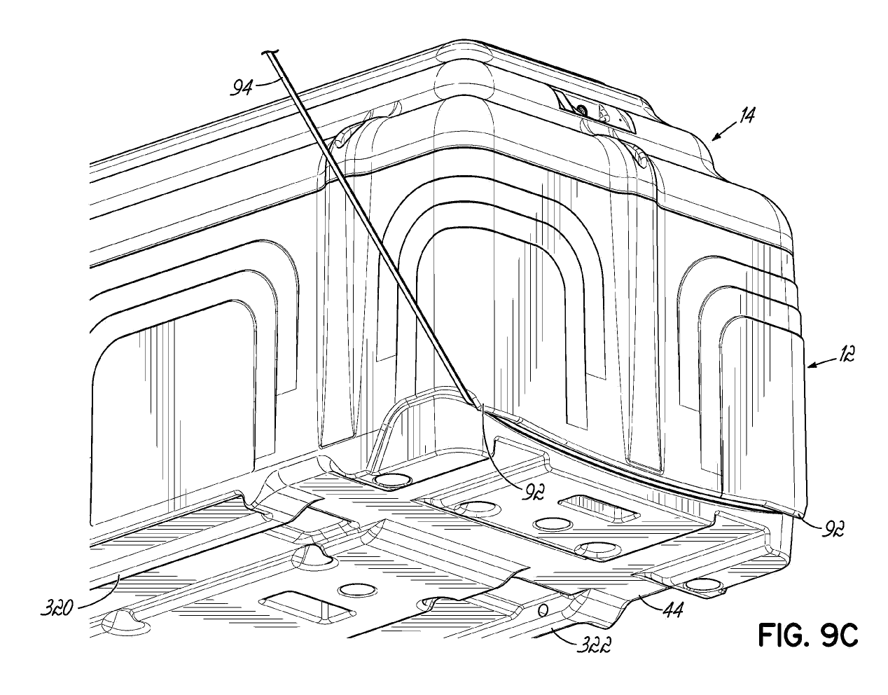

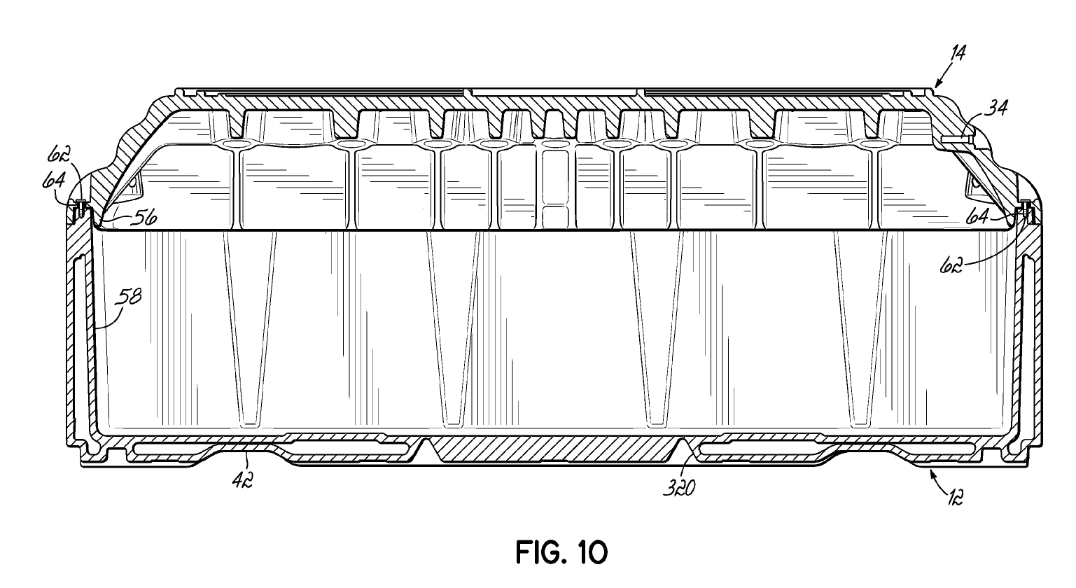

Referring to FIGS. 9A-9C, the vault base 12 can include a pair of end walls 90, 90 and can further include a cable lip or ledge 92 extending across each end wall 90 and adapted to receive a length of cable 94 positioned thereunder such that the cable 94 can be used to raise or lower the vault 10. This feature can be especially helpful in the event the vault 10 is required to be disinterred.

Referring to FIG. 2A, the vault 10 can further include an axle 100 removably mounted to the vault base 12 and a wheel 102 removably mounted to each end of the axle 100, and a handle 104 removably mounted to the vault 10. The handle 104 can include a first pair of ends 106, 106 received underneath the vault base 12, a second pair of ends 108, 108 adapted to be grasped by a user, and structure 110 between the first 106, 106 and second 108, 108 pair of ends that engages an end wall 90 of the vault 10. Lifting the second pair of ends 108, 108 creates a couple applied to the vault 10 by the structure 110 and first pair of ends 106, 106 thereby permitting an end of the vault 10 to which the handle 104 is mounted to be lifted by the user.

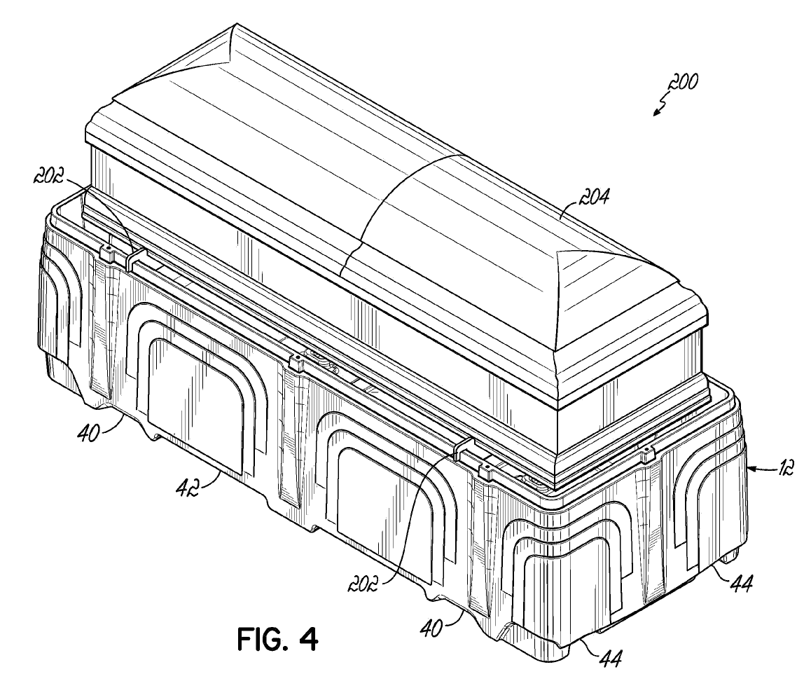

In another aspect, and referring now to FIGS. 4-7, a vault and casket display 200 comprises a vault base 12, a pair of supports 202, 202 spanning the vault base 12, and a casket 204 supported on the pair of supports 202, 202. The vault base 12 has upper side edges 210 and each of the supports 202 can have a downturned end portion 212 that fits over a respective upper side edge 210 of the vault base 12. Such a display allows a vault of the type herein described to be displayed with a casket in a funeral home selection room. Conventional concrete vaults, weighing ten times or more the weight of the vault herein described, do not lend themselves to being displayed inside a funeral home due to their size and weight.

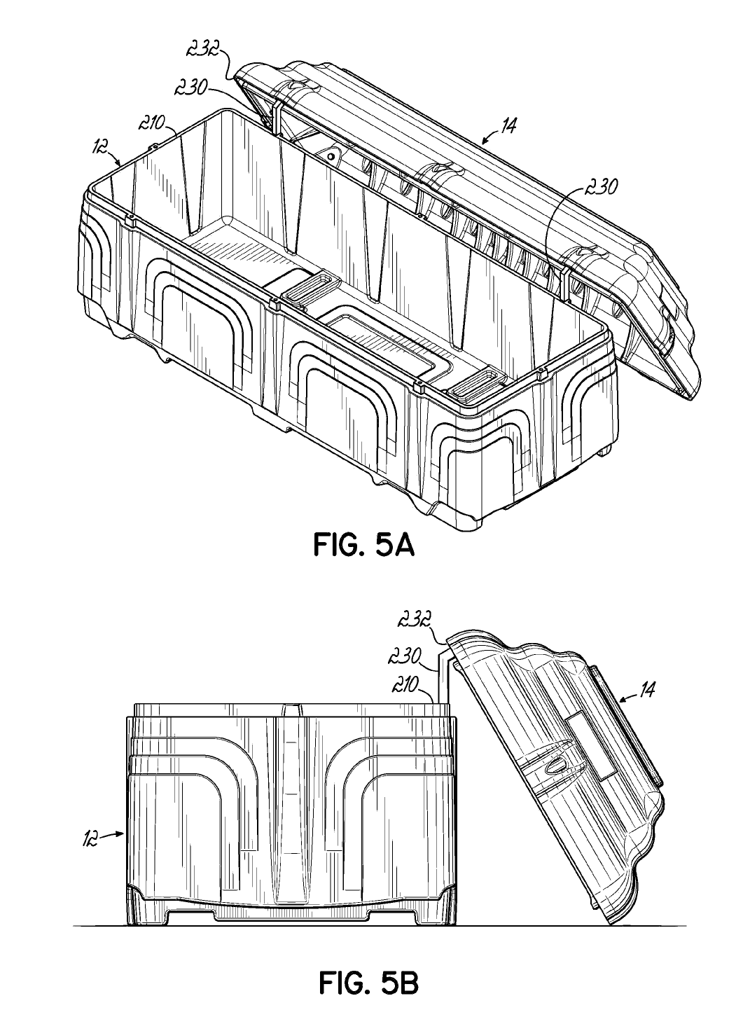

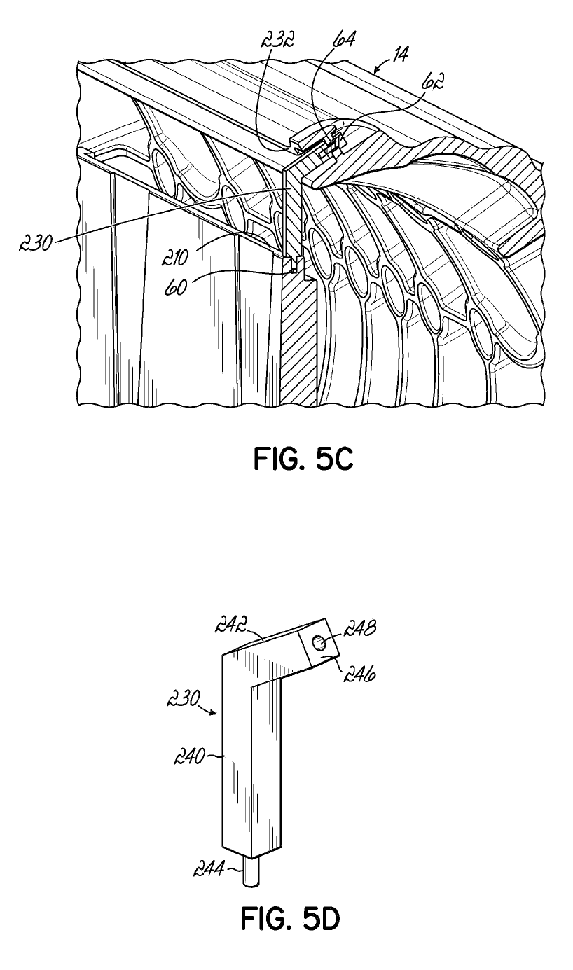

Referring to FIGS. 5A-5D, the display 200 can further comprise a pair of posts 230, 230 that engage an upper side edge 210 of the vault base 12 and that also engage a side edge 232 of the vault lid 14 and position the lid 14 at an angle of between about 0 degrees and about 90 degrees relative to a generally horizontal support surface, for example floor, atop which the vault base 12 and vault lid 14 are supported. For example, angles of about 45 degrees to about 60 degrees can be used. As mentioned above, the vault base 12 can include a plurality of threaded inserts 60 in the upper side edge 210 and the vault lid 14 can include a plurality of through holes 64 in the side edge 232. Each of the posts 230 can include a generally vertical portion 240 and an upwardly and forwardly extending portion 242 at an upper end of the generally vertical portion 240. The generally vertical portion 240 includes a threaded lower end 244 which is threaded into one of the threaded inserts 60 in the vault upper side edge 210, and an end 246 of the upwardly and forwardly extending portion 242 includes a tapped hole 248 therein. A threaded fastener, for example one of the stainless steel bolts 62, is inserted through one of the through holes 64 in the vault lid side edge 232 and is threaded into the tapped hole 248. A pair of such posts can be used to secure the vault lid 14 to the vault base 12 for display purposes.

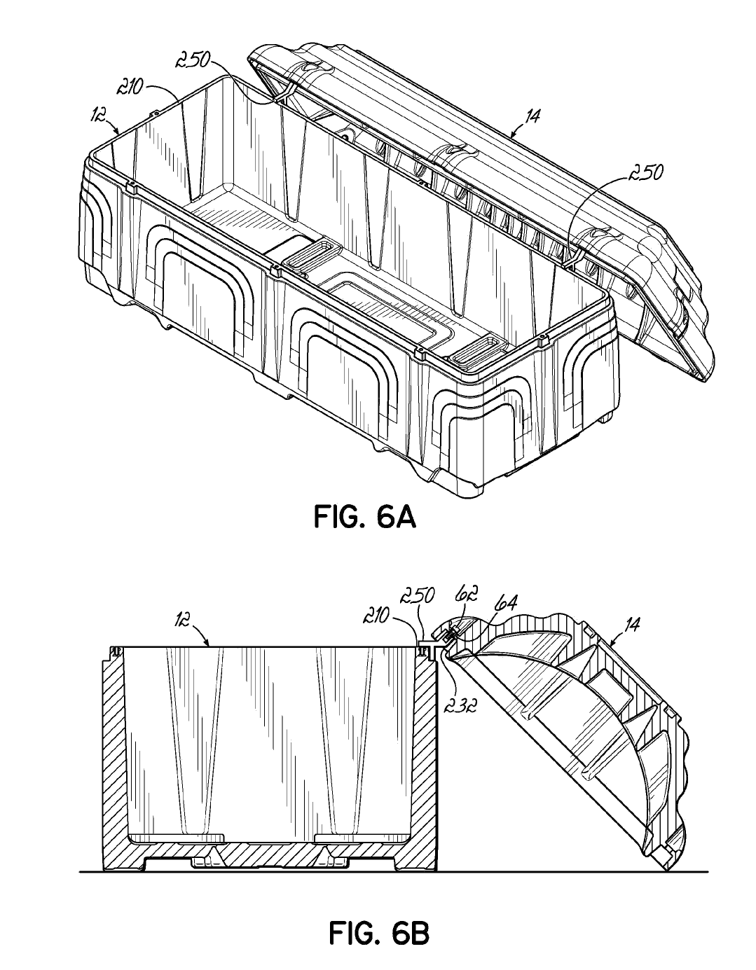

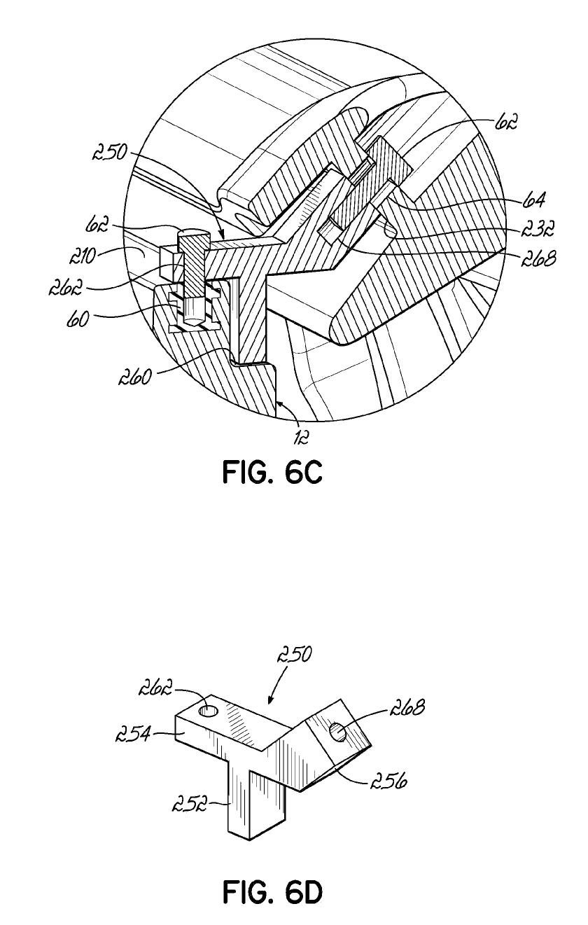

Alternatively, and referring now to FIGS. 6A-6D, each of these posts 250 can include a generally vertical portion 252, a generally horizontal portion 254 extending in a rearward direction from an upper end of the generally vertical portion 252, and an upwardly and forwardly extending portion 256 extending from the upper end of the generally vertical portion 252. The generally vertical portion 252 can rest atop a ledge 260 of the vault base 12. The generally horizontal portion 254 includes a through hole 262. A first threaded fastener, for example one of the stainless steel bolts 62, is inserted through the through hole 262 and is threaded into one of the threaded inserts 64 in the upper edge 210 of the vault base 12. An end of the upwardly and forwardly extending portion 256 has a tapped hole 268 therein, and a second threaded fastener, for example one of the stainless steel bolts 62, is inserted through one of the through holes 64 in the vault lid edge 232 and is threaded into the tapped hole 268.

The posts and display techniques of FIGS. 5A-5D and FIGS. 6A-6D showcase the memorialization features of the vault lid 14, for example memorialization panels 30 and 32 and memorial record tube assembly 36, by orienting the vault lid 14 for convenient viewing of the upper surface of the lid 14 by funeral home customers in the funeral home selection room.

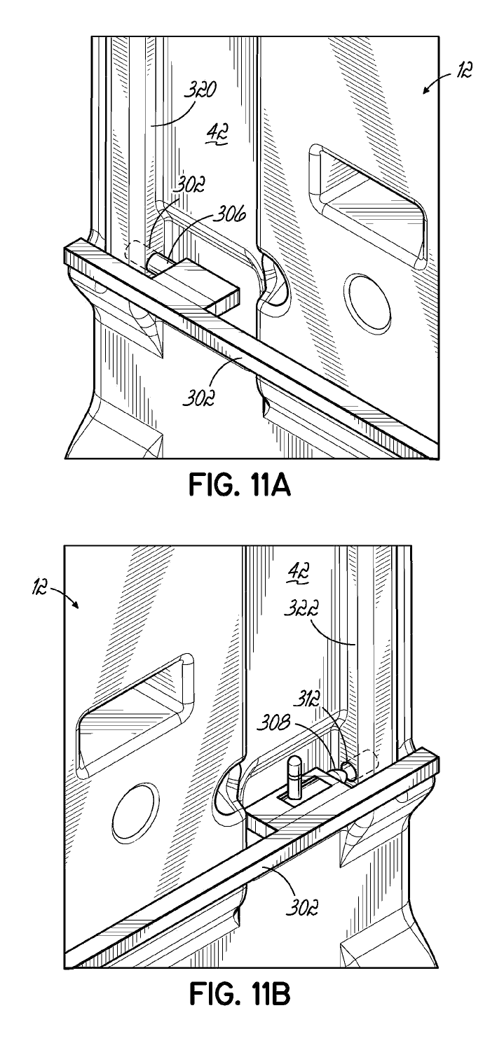

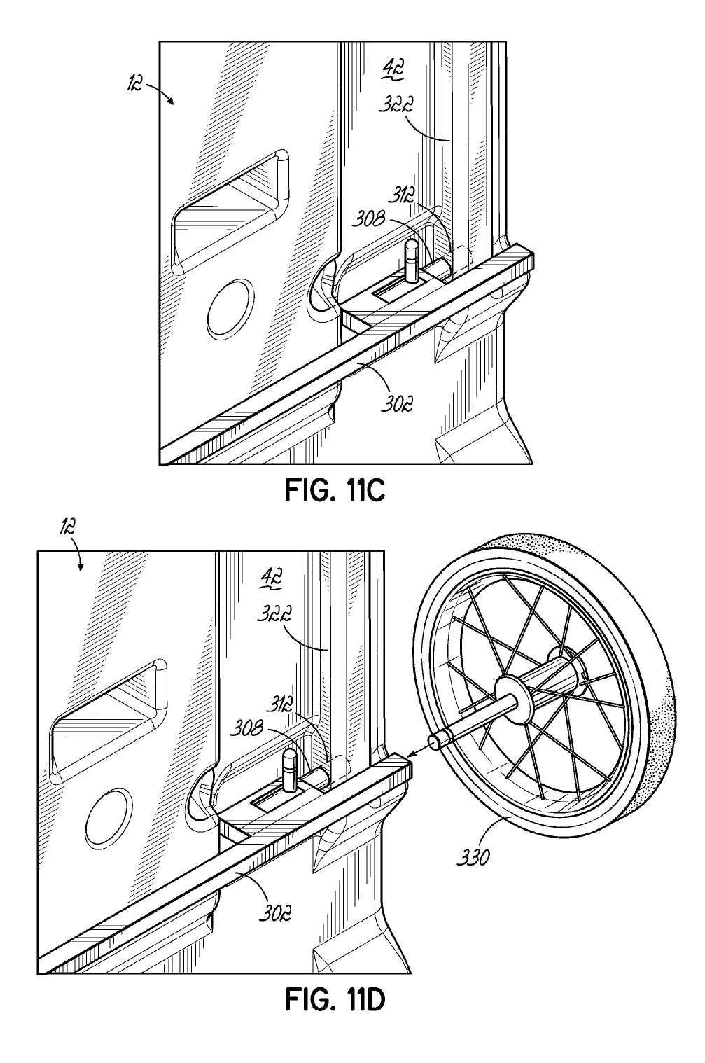

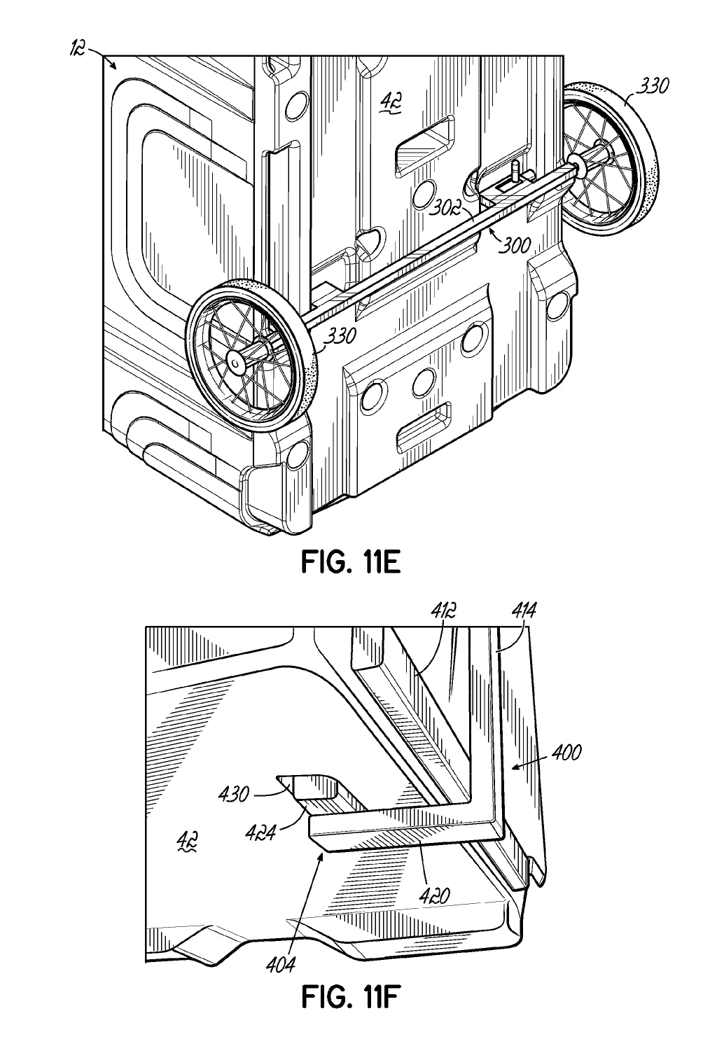

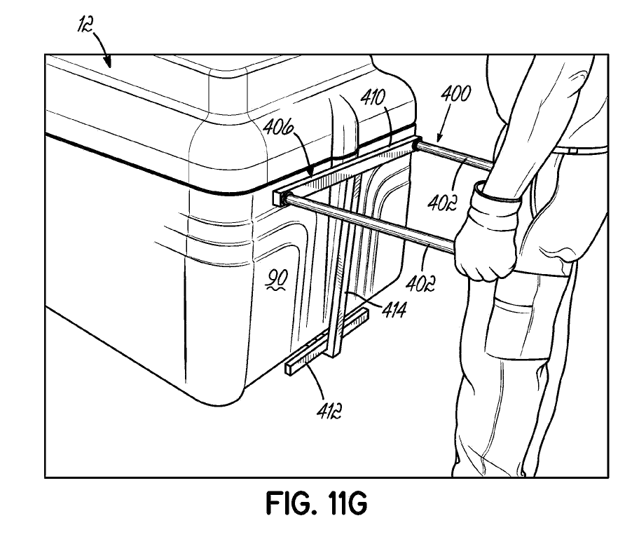

Referring to FIGS. 11A-11G, alternative embodiments of a wheel and axle assembly 300 and a handle assembly 400 are illustrated. The wheel and axle assembly 300 comprises an axle 302 removably mounted to the vault base 12 and a wheel 304 removably mounted to each end of the axle 302. The axle 302 can include a stationary pin 306 attached to the axle 302 near one end of the axle 302 and a spring loaded pin 308 attached to the axle 302 near another end of the axle 302. The pins 306, 308 are removably received in holes 310, 312 in the bottom 42 of the vault base 12. For example, holes 310, 312 can be a blind hole in respective longitudinally extending ribs 320, 322 in the bottom 42 of the vault base 12. The axle 302 can be a rectangular tube each end of which removably receives a wheel 330.

The handle assembly 400 can include a pair of rearwardly extending handles 402, 402 adapted to be grasped by a user, a forwardly extending foot 404 adapted to engage the bottom 42 of the vault base 12, and structure 406 between the handles 402, 402 and the foot 404 adapted to engage an end wall 90 of the vault base 12. Lifting the pair of handles 402, 402 creates a couple applied to the vault base 12 permitting the end of the vault 10 to which the handle assembly 400 is mounted to be lifted by a user. The handle assembly 400 can further comprise an upper horizontal member 410, a lower horizontal member 412, and a vertical member 414 connected to the upper and lower horizontal members 410, 412. The handle assembly 400 can further comprise a forwardly extending member 420 connected to a lower end of the vertical member 414, with the foot 404 being connected to the forward end of the forwardly extending member 420. The foot 404 can be a horizontal member 424 connected to an upper surface of the forward end of the forwardly extending member 420. The bottom 42 of the vault base 12 can include a pocket or recess 430 formed therein to receive the horizontal member 424. The handles 402, 402 can be round tubes and the upper and lower horizontal members 410, 412, vertical member 414, forwardly extending member 420, and horizontal member 424 can be rectangular tubes.

The embodiments shown and described are merely for illustrative purposes only. The drawings and the description are not intended to limit in any way the scope of the claims. Those skilled in the art will appreciate various changes, modifications, and other embodiments. All such changes, modifications and embodiments are deemed to be embraced by the claims. Accordingly, the scope of the right to exclude shall be limited only by the following claims and their equivalents.

What is claimed is:

1. A vault comprising:
a vault base,
a vault lid on said base, said lid including structure on an upper surface thereof for receiving memorialization panels, and
at least one said memorialization panel received by said receiving structure on said lid.

2. The vault of claim 1 wherein said memorialization panel receiving structure comprises a pair of generally rectangular frames separated by a generally oval frame, and wherein said at least one memorialization panel comprises a pair of generally rectangular memorialization panels, one of which is received in each generally rectangular frame, and a generally oval memorialization panel received in said generally oval frame.

3. The vault of claim 1 wherein said vault lid includes a generally horizontally oriented threaded hole for threadably receiving a memorial record tube assembly therein.

4. The vault of claim 3 further comprising a rectangular plaque which covers an end of said memorial record tube assembly installed in said hole.

5. The vault of claim 1 further including a pair of transverse slots in an outer surface of a bottom of said vault base.

6. The vault of claim 1 further including a pair of longitudinal slots in an outer surface of a bottom of said vault base.

7. The vault of claim 1 further including a pair of transverse slots in an outer surface of a bottom of said vault base and a pair of longitudinal slots in said outer surface of said bottom of said vault base.

8. The vault of claim 1 further including a gasket between said vault lid and said vault base that is compressed between confronting lid and base generally horizontal surfaces and between confronting lid and base generally vertical surfaces during securement of said lid on said base.

9. The vault of claim 8 wherein said gasket is a generally planar gasket.

10. The vault of claim 8 wherein said base includes threaded inserts molded therein and said lid is secured to said base by bolts that pass through holes in said vault lid and are threaded into said inserts in said base.

11. The vault of claim 10 wherein there are three said inserts and bolts per side of said vault and one said insert and bolt per end of said vault.

12. The vault of claim 1 wherein said vault base and lid each have inner and outer walls and wherein a structural filler material is disposed between said inner and outer walls.

13. The vault of claim 12 wherein said inner and outer walls of said base and lid are fabricated of a synthetic resinous material.

14. The vault of claim 13 wherein said structural filler material is structural foam.

15. The vault of claim 1 wherein said vault base includes a pair of end walls and further including a cable ledge extending across each said end wall and adapted to receive a length of cable positioned thereunder such that the cable can be used to raise or lower said vault.

16. The vault of claim 1 further including an axle removably mounted to said vault base and a wheel removably mounted to each end of said axle, and a handle removably mounted to said vault, said handle including a first pair of ends received underneath said vault base, a second pair of ends adapted to be grasped by a user, and structure between said first and second pair of ends that engages an end wall of said vault, whereby lifting said second pair of ends creates a couple applied to said vault thereby permitting an end of said vault to which said handle is mounted to be lifted by the user.

17. A vault and casket display comprising:
a vault base,
a pair of supports spanning said vault base, and
a casket supported on said pair of supports.

18. The display of claim 17 wherein said vault base has upper side edges and wherein each of said supports has a downturned end portion that fits over a respective upper side edge of said vault base.

19. The display of claim 17 further comprising a pair of posts that engage an upper side edge of said vault base and that also engage a side edge of said vault lid and position said lid at an angle of between about 0 degrees and about 90 degrees relative to a generally horizontal support surface atop which said vault base and vault lid are supported.

20. The display of claim 19 wherein said posts position said lid at an angle of about 60 degrees relative to the generally horizontal support surface.

21. The display of claim 19 wherein said posts position said lid at an angle of about 45 degrees relative to the generally horizontal support surface.

22. The display of claim 18 wherein said vault base includes a plurality of threaded inserts in said upper side edge and said vault lid includes a plurality of through holes in said side edge, and wherein each of said posts includes a generally vertical portion and an upwardly and forwardly extending portion at an upper end of said generally vertical portion, said generally vertical portion including a threaded lower end which is threaded into one of said threaded inserts in said vault upper side edge, an end of said upwardly and forwardly extending portion including a tapped hole therein, and a threaded fastener inserted through one of said through holes in said vault lid side edge and threaded into said tapped hole.

23. The display of claim 18 wherein said vault base includes a plurality of threaded inserts in said upper side edge and said vault lid includes a plurality of through holes in said side edge, and wherein each of said posts includes a generally vertical portion, a generally horizontal portion extending in a rearward direction from an upper end of said generally vertical portion, and an upwardly and forwardly extending portion extending from said upper end of said generally vertical portion, said generally vertical portion resting atop a ledge of said vault base, said generally horizontal portion including a through hole, a first threaded fastener inserted through said through hole and threaded into one of said threaded inserts in said upper edge of said vault base, an end of said upwardly and forwardly extending portion having a tapped hole therein, and a second threaded fastener inserted through one of said through holes in said vault lid edge and threaded into said tapped hole.

24. The vault of claim 1 further including an axle removably mounted to said vault base and a wheel removably mounted to each end of said axle, said axle including a stationary pin attached near one end thereof and a spring loaded pin attached near an opposite end thereof, said pins removably received in respective holes in a bottom of said vault base.

25. The vault of claim 24 wherein each said hole is a blind hole in a longitudinal extending rib of said bottom of said vault base.

26. The vault of claim 24 wherein said axle is a rectangular tube and wherein each said wheel is adapted to removably mate with said rectangular tube.

27. The vault of claim 1 further including a handle assembly removably mounted to said vault, said handle assembly including a pair of rearwardly extending handles adapted to be grasped by a user, a forwardly extending foot adapted to engage a bottom of said vault, and structure between said handles and said foot adapted to engage an end wall of said vault, whereby lifting said pair of handles creates a couple applied to said vault thereby permitting an end of said vault to which said handle assembly is mounted to be lifted by the user.

28. The vault of claim 27 wherein said handle assembly further comprises an upper horizontal member, each of said pair of handles connected to a respective end of said horizontal member, a lower horizontal member, and a vertical member connected to said upper horizontal member and said lower horizontal member at respective ends of said vertical member.

29. The vault of claim 28 wherein said handle assembly further comprises a forwardly extending member connected to a lower end of said vertical member, said foot being connected to a forward end of said forwardly extending member.

30. The vault of claim 29 wherein said foot is a horizontal member connected to an upper surface of said forward end of said forwardly extending member.

31. The vault of claim 30 wherein each of said pair of handles is a round tube, and wherein said upper and lower horizontal members, said vertical member, said forwardly extending member, and said foot horizontal member are rectangular tubes.

32. The vault of claim 27 further including a pocket formed in a bottom of said vault base which receives said foot.

33. A casket vault comprising:
a vault base adapted to receive therein a casket,
a vault lid closable on said vault base,
a wheel and axle assembly removably mounted to said vault base, said wheel and axle assembly including an axle removably mounted to said vault base and a wheel removably mounted to each end of said axle, and
a handle assembly removably mounted to said vault base, said handle assembly including a pair of rearwardly extending handles adapted to be grasped by a user, a forwardly extending foot adapted to engage a bottom of said vault base, and structure between said handles and said foot adapted to engage an end wall of said vault base, whereby lifting said pair of handles creates a couple applied to said vault thereby permitting an end of said vault to which said handle assembly is mounted to be lifted by the user and rolled on said wheels.

34. The vault of claim 33 wherein said axle includes a stationary pin attached near one end thereof and a spring loaded pin attached near an opposite end thereof, said pins removably received in respective holes in said bottom of said vault base.

35. The vault of claim 34 wherein each said hole is a blind hole in a longitudinal extending rib of said bottom of said vault base.

36. The vault of claim 33 wherein said axle is a rectangular tube and wherein each said wheel is adapted to removably mate with said rectangular tube.

37. The vault of claim 33 wherein said handle assembly further comprises an upper horizontal member, each of said pair of handles connected to a respective end of said horizontal member, a lower horizontal member, and a vertical member connected to said upper horizontal member and said lower horizontal member at respective ends of said vertical member.

38. The vault of claim 37 wherein said handle assembly further comprises a forwardly extending member connected to a lower end of said vertical member, said foot being connected to a forward end of said forwardly extending member.

39. The vault of claim 38 wherein said foot is a horizontal member connected to an upper surface of said forward end of said forwardly extending member.

40. The vault of claim 39 wherein each of said pair of handles is a round tube, and wherein said upper and lower horizontal members, said vertical member, said forwardly extending member, and said foot horizontal member are rectangular tubes.

41. The vault of claim 33 further including a pocket formed in said bottom of said vault base which receives said foot.

42. The vault of claim 33 wherein said vault base and lid each have inner and outer walls and wherein a structural filler material is disposed between said inner and outer walls.

43. The vault of claim 42 wherein said inner and outer walls of said base and lid are fabricated of a synthetic resinous material.

44. The vault of claim 43 wherein said structural filler material is structural foam.
